(19) United States
(12) Patent Application Publication
(10) Pub. No.: US 2021/0323239 A1
(43) Pub. Date: Oct. 21, 2021

(54) DETERMINING COOLING AGENT AMOUNTS

(71) Applicant: HEWLETT-PACKARD DEVELOPMENT COMPANY, L.P., Spring, TX (US)

(72) Inventors: Sergio Gonzalez, Sant Cugat del Valles (ES); Ismael Fernandez Aymerich, Sant Cugat del Valles (ES); Emili Sapena Masip, Sant Cugat del Valles (ES)

(21) Appl. No.: 16/605,333

(22) PCT Filed: Apr. 30, 2018
(86) PCT No.: PCT/US2018/030124

§ 371 Date: Oct. 15, 2019

(51) Int. Cl. B29C 64/393; B29C 64/153; B33Y 10/00; B33Y 30/00; B33Y 50/02

(52) U.S. Cl. CPC B29C 64/393; B29C 64/153; B33Y 50/02; B33Y 30/00; B33Y 10/00

(57) ABSTRACT

In an example, a method includes determining, using at least one processor, a proportion of a layer of build material which is intended to remain unfused in an additive manufacturing process. Based on the proportion, an amount of cooling agent to apply to the layer of build material may be determined.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Non-limiting examples will now be described with reference to the accompanying drawings, in which:

FIG. 1 is a flowchart of an example method of processing data for use in additive manufacturing;

FIG. 2A shows an example of objects and FIGS. 2B and 2C show layer-by-layer temperatures of manufacture of the object employing different methods of processing data;

FIG. 3 is a flowchart of an example method of generating an object using additive manufacturing;

FIG. 4 is a flowchart of an example method of generating a predicted heat distribution map:

FIGS. 5 and 6 are simplified schematic drawings of example apparatus for use in additive manufacturing;

FIG. 7 is a simplified schematic drawing of an example machine readable medium associated with a processor; and

FIG. 8 is an example showing dimensional accuracies of detailing agent determination methods.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60Q “HP fusing agent” available from HP Inc. In one example such a fusing agent may comprise an infra-red light absorber. In one example such a fusing agent may comprise any or any combination of near infra-red light absorber, a visible light absorber, and a UV light absorber. Examples of print agents comprising visible light absorption enhancers are dye based colored ink and pigment based colored ink, such as inks commercially referred to as CE039A and CE042A available from HP Inc.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, a coalescence modifier agent may have a cooling effect, and thus be termed ‘cooling agent’. In some examples, the detailing agent may be used in particular near edge surfaces of an object being printed, although they may also be used in other regions, and may for example be distributed according to a distribution map or pattern, which may be derived from data representing a slice of a three-dimensional object to be generated. According to one example, a suitable detailing agent may be a formulation commercially referred to as V1Q61A “HP detailing agent” available from HP Inc. In some examples, the detailing agent is an aqueous composition (comprising a high percentage of water) which undergoes evaporation when heated, resulting in a cooling effect.

A coloring agent, for example comprising a dye or colorant, may in some examples be used as a fusing agent or a coalescence modifier agent, and/or as a print agent to provide a particular color for the object.

As noted above, additive manufacturing systems may generate objects based on structural design data. This may involve a designer generating a three-dimensional model of at least one object to be generated, for example using a computer aided design (CAD) application. The model may define the solid portions of the object(s). To generate three-dimensional object(s) from the model using an additive manufacturing system, model data can be processed to generate slices of parallel planes or slices of the model. Each slice may define a portion of a respective layer of build material that is to be solidified or caused to coalesce by the additive manufacturing system.

During object generation, at least one energy source, for example infrared sources, heat lamps and the like, which may be static and/or scanned over the surface of a layer of build material on a print bed, may be used to provide energy. It has been noted that the temperature of a layer has a relationship with the amount of build material on which no fusing agent has been applied. While temperatures may be expected to increase when there is more fusing agent applied, it has been noted that temperatures could also increase with the amount of build material which is not treated with fusing agent. Without wishing to be bound by theory, this may be because, while fusing agent tends to absorb heat, build material which is not treated with fusing agent tends to be at least partially reflective. As the energy sources are often equipped with reflectors and/or concentrators, reflected energy is ‘re-reflected’ back towards the print bed. This ‘re-reflected’ or re-radiated energy may therefore be higher in the case of a layer with a high proportion of build material which is not treated with fusing agent than in the case of a layer with a low proportion of build material which is not treated with fusing agent.

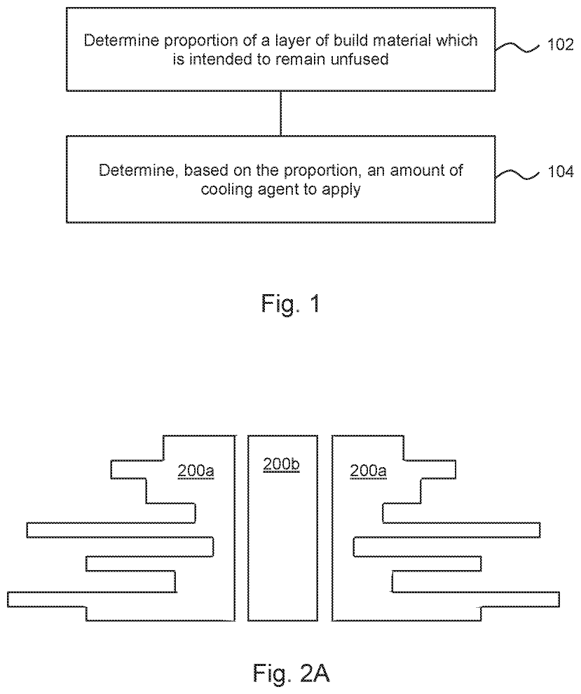

FIG. 1 is an example of a method, which may comprise a computer implemented method for determining an amount of cooling agent to apply to a layer of build material, in some examples to compensate for the variability of additional heating caused by reflected energy between layers. The method comprises, in block 102, determining a proportion of a layer of build material which is intended to remain unfused in an additive manufacturing process.

In some examples, this may comprise analysing object model data which represents at least one object to be generated by an additive manufacturing apparatus by fusing build material. The object model may comprise data representing at least a portion (in some examples, a slice) of an object to be generated by an additive manufacturing apparatus by fusing a build material. The object model data may for example comprise a Computer Aided Design (CAD) model, and/or may for example be a STereoLithographic (STL) data file.

In some examples, the model data may represent the object or object region as a plurality of sub-volumes, wherein each sub-volume represents a region of the object which is individually addressable in object generation. In some examples herein, the sub-volumes may be referred to as voxels, i.e. three-dimensional pixels, wherein each voxel occupies or represents a discrete volume. In some examples of additive manufacturing, three-dimensional space may be characterised in terms of such voxels. In some examples, the voxels are determined bearing in mind the print resolution of an object generation apparatus, such that each voxel represents a region which may be uniquely addressed when applying print agents, and therefore the properties of one voxel may vary from those of neighbouring voxels. In other words, a voxel may correspond to a volume which can be individually addressed by an object generation apparatus (which may be a particular object generation apparatus, or a class of object generation apparatus, or the like) such that the properties thereof can be determined at least substantially independently of the properties of other voxels. For example, the ‘height’ of a voxel may correspond to the height of a layer of build material. In some examples, the resolution of an object generation apparatus may exceed the resolution of a voxel. In general, the voxels of an object model may each have the same shape (for example, cuboid or tetrahedral), but they may in principle differ in shape. In some examples, voxels are cuboids, for example based on the height of a layer of build material. In some examples, in processing data representing an object, each voxel may be associated with properties, and/or to object generation instructions, which apply to the voxel as a whole. When considered in terms of a particular slice of a model, voxels may be referred to as pixel locations, or simply pixels. A pixel may also be a pixel of a heat map, which may be determined based on the resolution of a thermal imaging camera, or other temperature sensing apparatus.

In some examples, the determination of block 102 may be carried out on a slice by slice basis. In some examples, the slice may be a slice of a virtual build volume modelling an intended ‘real’ build volume (for example, the intended content of a fabrication chamber), and may comprise slices taken from a model of more than one object. In some examples, the slices may be one voxel thick.

In some examples the determination of block 102 may comprise determining a plurality of values which are indicative of a local density. In other words, a density ‘map’ of a slice of a virtual build volume may be determined. In some examples, this map may vary in two dimensions (for example with each of a plurality of pixels being assigned a value based on how many neighboring pixels comprise part of an object, and how many do not), while in other examples the map may vary in one dimension (for example with voxel resolution or some other resolution, for example dividing the layer into zones), as set out in greater detail below. In still further examples, a simple ratio of pixels which are intended to fuse, to pixels which are not intended to fuse may be determined to determine an indication of a local or layer density of object generation.

Block 104 comprises determining, using at least one processor, and based on the proportion determined in block 102, an amount of cooling agent to apply to the layer.

This method may therefore allow the amounts of cooling agent to vary between layers based on a proportion of build material which is to remain unfused. Moreover, in some examples, the determined amount of cooling agent may vary across the layer. For example, a cooling agent distribution ‘map’ may be determined for the layer, where the contone level (which comprises a defined scale for the amount of print agent applied which may relate to a volume in terms of the number of drops and/or the volume of drops or the like) of a cooling agent may vary over the layer. Such a distribution map may specify that cooling agent is printed both on parts of the layer which are to be fused, and those which are to remain un-fused. While such a map may previously have been determined to control the distribution of print agents including fusing agent and/or cooling agent, in this example, the distribution also takes into account the amount of unfused build material in a layer (which may compensate for a ‘re-reflectance’ effect caused by the reflectivity of build material to which energy absorbing agents such as fusing agent have been applied).

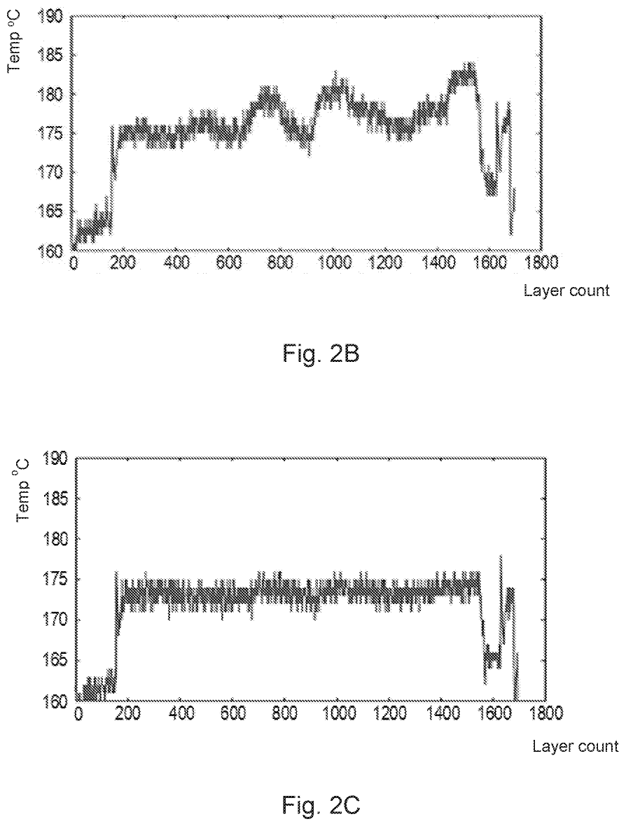

FIG. 2A shows a cross section of a first object 200a and a second object 200b. The first object 200a has an annular form (i.e. is fully rotationally symmetric with a central hole). As can be seen, at different heights in the first object 200a, the first object 200a has different diameters. The second object 200b comprises a cylinder which is positioned within the hole of the first object 200a.

FIG. 2B shows a central layer temperature (i.e. in this example a temperature of a pixel of a heat map of each layer, where the pixel is at the vertical midline of the second object 200b in each layer as generated) for an object generation process in which there is no compensation for the ratio of fused to unfused build material in each layer. In other words, if each layer is considered as an xy plane, with layers being built up in a z direction, the graph shows the temperature of a particular xy location in each of a plurality of layers having different z coordinates, with the layer number being shown on the horizontal axis.

In this example, cooling agent has been applied to the layer based on a predicted thermal or heat map of the layer, for example with the intention of maintaining the temperature of each pixel to be within a predetermined range (wherein the intended temperature of a pixel may vary depending on whether build material corresponding to that pixel is intended to fuse or not). For example, where a predicted temperature is above the intended temperature or temperature range, an amount of cooling agent may be specified for that pixel in object generation instructions, where the amount may specified may be depend on how much higher the temperature is compared to the intended temperature, with increasing amounts being specified for increasing temperatures. However, where the predicted temperature of a pixel is at the intended temperature or within the intended temperature range, object generation instructions may specify that no cooling agent is to be applied to that pixel. Example methods of generating a heat map/thermal distribution map are set out in greater detail below, although alternative techniques may be used in other examples. However, in this example the thermal map has been predicted based on the direct energy output of the energy sources (e.g. heat lamps), with no consideration of the reflections which may occur. In some examples, the amount of cooling agent around a perimeter of a portion of fused agent may be higher than in other parts of the layer to provide for well-defined object edges. In some examples, cooling agent may be applied at a consistent amount (e.g. at a consistent contone level) over all portions of the layer, or over all portions which are not intended to fuse, for example with the intention of producing a consistent layer temperature. As can be seen, there is temperature variability between the layers, with fusion of layers in which the object diameter is relatively small resulting in a higher temperature value for the central pixel.

In practice, (although not shown in FIG. 2A) hotter layers may suffer from greater dimensional inaccuracy and/or from adhesion of additional particles of build material to the external surfaces of the object. It may be noted that the central pixel varies in temperature between the layers even though the dimensions of the second object 200b are consistent.

The result of a method which employs the principles set out in FIG. 1 is shown in FIG. 2C. In this example, (ignoring the first and last few layers in which no object portion is generated) the central pixel temperature remains substantially more consistent despite changes in the proportion of an individual layer which is caused to fuse. In other words, the effect of a variable proportion of build material which is not intended to fuse on the temperature has been compensated for by the method of FIG. 1. In some examples, the compensation may for example comprise applying a consistent or blanket compensation to the contone level(s) of cooling agent across a whole layer. However, in this example, the correction is a local correction to a cooling agent distribution map and is based on a determined function which varies over the xy plane corresponding to a layer of build material, as further set out below.

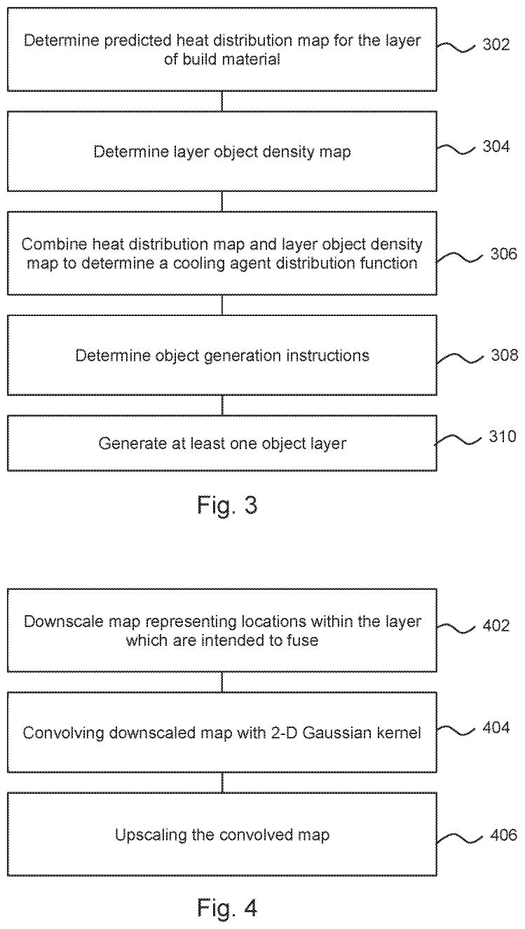

FIG. 3 shows an example of a particular way of carrying out the method of FIG. 1 in generating an object. In this example, the method comprises, in block 302, determining a predicted heat distribution map for the layer of build material. In some examples, this may comprise processing a map or plane representing a slice of a virtual build volume/object, which may indicate locations (for example, pixel locations) which are intended to fuse in object generation. In some examples, a heat diffusion model may be applied. For example, this may comprise convolving the map or plane with a 2D Gaussian kernel, which in effect simulates heat diffusion within the layer. However, alternative methods may model the heat distribution in different ways, for example by estimating an amount of fusing agent to be applied and assigning a temperature value to each of a plurality of pixels within the map/plane. The temperature values may be relative or absolute. Block 302 may therefore provide one example of a way of carrying out block 104 above.

Block 304 comprises determining a layer object density map. In some examples, this may comprise processing a map or plane representing a slice of a virtual build volume or object model, which may in some examples be the same map or plane used in block 302. In some examples, a linear, or one-dimensional model of the layer object density may be generated. For example, pixels in a particular layer which are intended to fuse may be identified and summed in columns, which may be one pixel wide (although in other examples, these columns may be more than one pixel wide). This provides a one-dimensional model of how object density is expected to vary across the print bed. In some examples, the columns may be formed in a direction of travel of heat lamps over a layer as this has been found to be an effective model for the density distribution (i.e. for determining a layer density map) when employed as part of methods described herein. In order to provide a layer of the same dimensions as the heat distribution map determined in block 304 (which may be convenient in terms of reducing computational resources), this one dimensional model may be duplicated over the original rows. Effectively, in some examples, this may be thought of as ‘spreading’ the one dimensional projection across the print bed in a direction of travel of a heat lamp over the print bed.

In other words, determining the proportion of a layer of build material which is intended to remain unfused may comprise partitioning the layer into a plurality of columns, and determining the proportion of each column which comprises build material which is intended to remain unfused.

Block 306 comprises combining, for example by multiplication on a pixel wise basis, the heat distribution map and the layer object density map to determine a cooling agent distribution function. If the one-dimensional projection is used for determining the layer object density map, this effectively means that the same one-dimensional row of the density map is multiplied with each row of the heat distribution map.

For example, this may result in an output of the form

$$out ( x , y ) = \{ \begin{matrix}{Max}_{CA} , mult ( x , y ) = 0 \\ 100 + ( \frac{A - B * {log}_{e} ( mult ( x , y ) )}{CA\_increase} ) , mult ( x , y ) > 0\end{matrix}$$

Where mult(x,y) is the pixel wise multiplication of the heat distribution map and the layer object density map in the xy plane of the layer, Max_{CA} is the maximum amount of cooling agent which may be applied by the object generation apparatus whilst still allowing the object portions (in particular where the local object density is low) to fuse, CA_increase is the change in temperature according to the contone level of the cooling agent (in this example in degrees centigrade, and relating to a predetermined contone scale), A and B are constants. The constants Max_{CA}, CA_increase, A and B may be dependent on the material, print agents and/or additive manufacturing apparatus, and the parameters thereof, used in object generation but may in principle be determined or predetermined for a particular set of operational parameters.

This results in an output plane or map, out(x,y), of correction percentages for cooling agent, which may in turn be applied to a distribution map of cooling agent which is determined without consideration of the amount of un-fused build material to be provided in a layer. This may result in cooling agent being applied across all parts of the layer, including where fusing agent is to be applied, and in the surrounding areas, with each xy location receiving an amount of cooling agent determined by the distribution function and the correction function out(x,y). Such an output may be used in order to generate an object having the temperature characteristics shown in FIG. 2C above.

It may be noted that out(x,y) is low when mult(x,y) is low, which in turn implies that at least one of density and predicted temperature is low.

This transform is optimised so as to result in a consistent processing time. It may be generally intended that the processing time of data relating to additive manufacturing is at least not significantly greater than the time to generate a layer of an object. This allows for consistent layer generation time (and therefore reduces complications in maintaining a consistent temperature in object generation) while also providing for efficient use of processing resources and memory resources.

Block 308 comprises determining object generation instructions for applying print agent to form at least one layer of an object. For example, cooling agent may be determined based on the principles set out above. In addition, the application of fusing agent may be determined based on a slice of an object model/virtual build volume, such that fusing agent is applied to the regions of build material which are intended to fuse. In some examples, other print agents may be specified, and/or object generation parameters such as temperatures, drop size, printhead speed, layer thickness, et cetera may also be specified. In some examples, techniques such as halftoning may be used to determine where drops of print agents are placed with within a layer.

Block 310 comprises generating at least one layer of an object based on the object generation instructions. This may comprise forming a layer of build material on a print bed or on a preceding layer of build material, selectively applying at least one print agent to the layer of build material and providing energy, for example heat to the layer, for example to cause fusing in parts thereof.

FIG. 4 is an example of one method for carrying out block 302 of FIG. 3. Block 402 comprises downscaling a map representing locations within the layer which are intended to fuse. For example, the map may be defined at a first resolution, comprising a grid of pixels of a first size. Downscaling the map may comprise combining pixels so as to create larger pixels at a second, lower resolution.

Block 404 comprises convolving the downscaled map with a 2D Gaussian kernel, which in effect simulates heat diffusion within the layer. Gaussian kernels act as spatial filters which ‘blur’ images, and may in effect operate as a moving window which is scanned across the map. The characteristics of the kernel may be determined or derived for example experimentally, empirically or through application of theory to result in a kernel which produces an intended result based on the thermal characteristics of the material(s) being used. In this case, the outlines of objects of a slice of an object model may be blurred such that the effect of heat diffusion from build material which refuses into surrounding build material may be modelled. Such a convolution exercise is generally computationally expensive. However, in this example, the downscaling in block 402 reduces computational resources used.

Block 406 comprises upscaling the output, for example using bilinear interpolation, to recover the original number of pixels. This may mean that it is the same size as a density distribution map and therefore the two may be readily combined.

While in this example the map is downscaled for computational efficiency (resulting in turn in the upscaling of block 406), this need not be the case in all examples. In some examples, convolution may be carried out at full resolution, and a kernel may be a different size (e.g. larger).

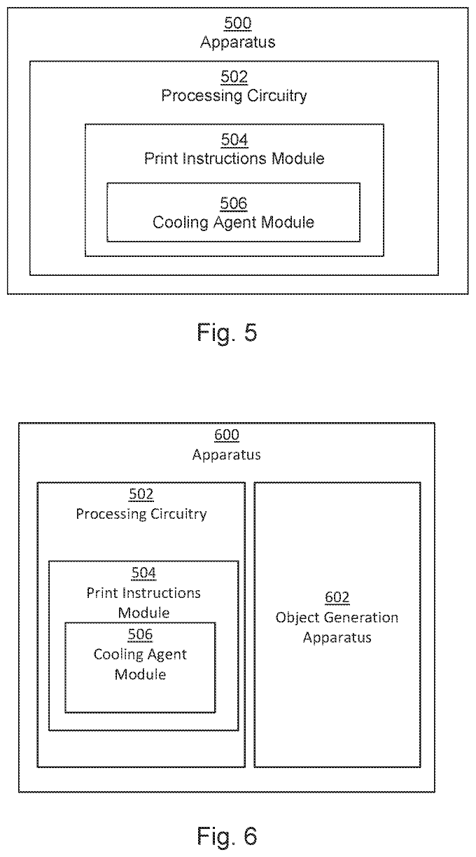

FIG. 5 shows an apparatus 500 comprising processing circuitry 502. The processing circuitry 502 comprises a print instruction module 504, which in turn comprises a cooling agent module 506.

In use of the apparatus 500, the print instruction module 504 determines a distribution of at least one print agent to be applied to a layer of build material in a layer by layer additive manufacturing process. The cooling agent module 506 determines an amount of cooling agent to be applied based on a proportion of build material to remain unfused in a layer.

As described above, this may comprise analysing object model data representing an object to be generated by an additive manufacturing apparatus, and generating a temperature distribution model (e.g. a heat map) indicative of a predicted temperature distribution within the object during object generation. As described above, in some examples, this analysis may be carried out on a slice by slice basis.

In some examples, in use of the apparatus 500, the cooling agent module 506, convolves a slice of object model data representing the object to be generated with a heat diffusion kernel to determine a thermal (heat) distribution map of the layer, as described above. In some examples, the cooling agent module 506 determines a density distribution map based a slice of object model data representing the object to be generated. In some examples, the cooling agent module 506 multiplies such a thermal distribution map and density distribution map to determine a cooling agent distribution map.

The print instruction module 504 may comprise additional processing modules, for example to generate print instructions for other print agents, such as fusing agents, dyes and the like, and print parameters, such as temperatures, speed, layer thickness, etc.

FIG. 6 shows an apparatus 600 comprising processing circuitry 502 which comprises the print instruction module 504 and the cooling agent module 506 as described above in relation to FIG. 5.

In this example, the apparatus 600 further comprises object generation apparatus 602.

In use of the apparatus 600, in this example, the print instruction module 504 generates control data to generate each of a plurality of layers of the object. This may for example comprise specifying area coverage(s) for print agents such as fusing agents, colorants, detailing/cooling agents and the like across each of a plurality of object layers. In some examples, object generation parameters are associated with object model voxels. In some examples, other parameters, such as any, or any combination of heating temperatures, build material choices, a number of printing passes, an intent of the print mode, and the like, may be specified. In some examples, halftoning may be applied to determined object generation parameters to determine where to place print agent or the like.

The object generation apparatus 602, in use of the apparatus 600, generates the object in a plurality of layers (which may correspond to respective slices of a virtual build volume/fabrication chamber) according to the generated control data. The object generation apparatus 602 may for example generate an object in a layer-wise manner by selectively solidifying portions of layers of build materials. The selective solidification may in some examples be achieved by selectively applying print agents, for example through use of ‘inkjet’ liquid distribution technologies, and applying energy, for example heat, to the layer. The object generation apparatus 602 may comprise additional components not shown herein, for example any or any combination of a fabrication chamber, a print bed, print head(s) for distributing print agents, a build material distribution system for providing layers of build material, energy sources such as heat lamps and the like, which are not described in detail herein.

The processing circuitry 502 or the modules thereof may carry out any of the blocks of FIG. 1, FIG. 3 or FIG. 4.

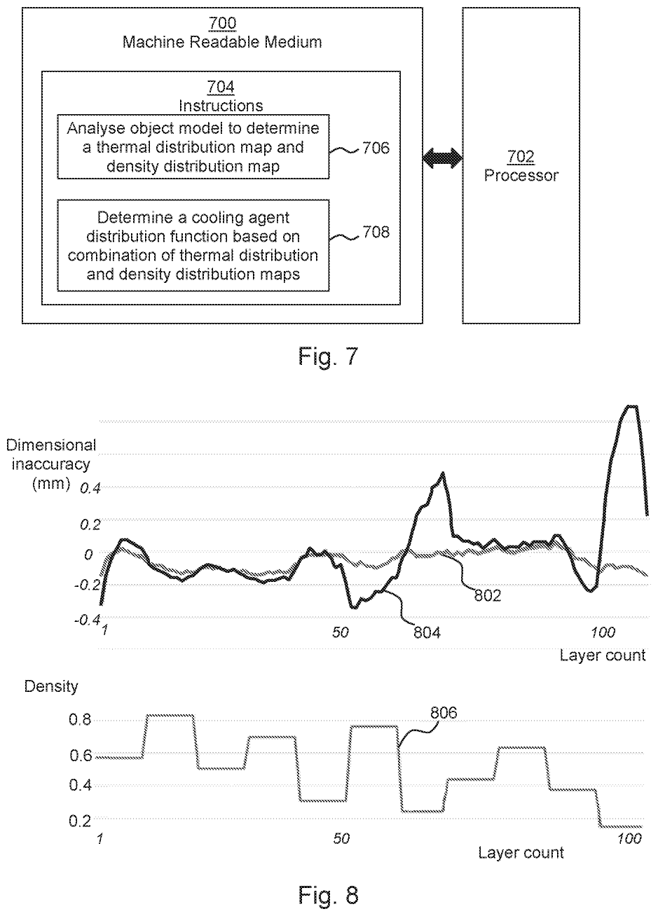

FIG. 7 shows a machine readable medium 700 associated with a processor 702. The machine readable medium 700 comprises instructions 704 which, when executed by the processor 702, cause the processor 702 to carry out processes. The instructions 704 comprise instructions 706 to cause the processor 702 to analyse object model data representing a slice of object to be generated in a layer in an additive manufacturing apparatus to determine a thermal distribution map and a density distribution map of the layer. The instructions 704 further comprise instructions 708 to cause the processor 702 to determine a cooling agent distribution function for the layer based on a combination of the thermal distribution map and density distribution map, wherein the cooling agent distribution function is to compensate for heat reflectance by build material of the layer which is not intended to fuse. In some examples, the cooling agent distribution function is to determine a correction factor for an amount of print agent to be applied at each of a plurality of locations across the layer.

In examples, the machine readable medium 700 may comprise instructions to carry out any, or any combination, of the blocks of FIG. 1, 3 or 4, or to act as part of the processing circuitry 502 of FIG. 5 or 6.

FIG. 8 shows an example comparing dimensional accuracy of an object in millimetres (mm) formed using a method in which the amount of cooling agent has been varied based on the proportion of build material which is to remain unfused in the layer according to the methods set out herein (line 802) and a method in which no compensation has been applied (line 804). In addition, an indication of the layer by layer density (line 806) is shown to demonstrate the effect. The density is provided as a ratio of between 0 and 1.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus (such as the print instruction module 504 and/or the cooling agent module 506) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
determining, using at least one processor, a proportion of a layer of build material which is intended to remain unfused in an additive manufacturing process; and
determining, using at least one processor, based on the proportion, an amount of cooling agent to apply to the layer of build material.

2. A method according to claim 1 wherein the determined amount of cooling agent to apply is higher when the proportion of the layer which is intended to remain unfused is higher than when the proportion of the layer which is intended to remain unfused is lower.

3. A method according to claim 1 comprising:
determining, using at least one processor, a predicted heat distribution map for the layer of build material;
determining, using at least one processor, a layer object density map; and
combining, using at least one processor, the predicted heat distribution map with the layer object density map to determine a cooling agent distribution function.

4. A method according to claim 3 wherein determining the predicted heat distribution map comprises convolving a map representing locations within the layer which are intended to fuse with a 2D Gaussian kernel.

5. A method according to claim 4 comprising downscaling the map representing locations within the layer which are intended to fuse prior to convolving the map with the 2D Gaussian kernel.

6. A method according to claim 3 comprising using the cooling agent distribution function to determine, using at least one processor, an amount of cooling agent for each of a plurality of locations in the layer of build material.

7. A method according to claim 1 wherein determining the proportion of a layer of build material which is intended to remain unfused comprises partitioning the layer into a plurality of columns, and determining a proportion of each column which comprises build material which is intended to remain unfused.

8. A method according to claim 1 further comprising generating at least one layer of an object using the determined amount of cooling agent.

9. Apparatus comprising processing circuitry, the processing circuitry comprising:
a print instruction module to determine a distribution of at least one print agent to be applied to a layer of build material in a layer by layer additive manufacturing process; the print instructions module comprising:
a cooling agent module to determine an amount of cooling agent to be applied based on a proportion of build material to remain unfused in a layer.

10. Apparatus according to claim 9 wherein the cooling agent module is to convolve a slice of object model data representing an object to be generated with a heat diffusion kernel to determine a thermal distribution map of the layer.

11. Apparatus according to claim 10 wherein the cooling agent module is to determine a density distribution map based on a slice of object model data representing the object to be generated.

12. Apparatus according to claim 11 wherein the cooling agent module is to multiply the thermal distribution map and the density distribution map to determine a cooling agent distribution map.

13. Apparatus according to claim 9 further comprising additive manufacturing apparatus to generate an object.

14. A machine readable medium comprising instructions which, when executed by a processor, cause the processor to:
analyse object model data representing a slice of an object to be generated in a layer in an additive manufacturing apparatus to determine a thermal distribution map and a density distribution map of the layer; and
determine a cooling agent distribution function for the layer based on a combination of the thermal distribution map and density distribution map, wherein the cooling agent distribution function is to compensate for heat reflectance by build material of the layer which is not intended to fuse.

15. A machine readable medium according to claim 14 wherein the cooling agent distribution function is to determine a correction factor for an amount of cooling agent to be applied at each of a plurality of locations across the layer.
